(19) United States
(12) Patent Application Publication
(10) Pub. No.: US 2010/0108561 A1
(43) Pub. Date: May 6, 2010

(54) PUMPKIN CARVING KIT FOR CARVING SEXUALLY THEMED IMAGES

(75) Inventor: Thomas M. Bramhall, Mooresville, NC (US)

Correspondence Address: Christopher C. Dremann, P.C., 8116 South Tryon Street, Suite B-3, Box 261, Charlotte, NC, 28273, US

(73) Assignee: Tommy B. Enterprises, LLC d/b/a PORNKINS, LLC, Mooresville, NC (US)

(21) Appl. No.: 12/262,673

(22) Filed: Oct. 31, 2008

(51) Int. Cl. B65D 71/00; B43L 7/00; B26F 1/00; F21S 6/00

(52) U.S. Cl. 206/575; 33/566; 30/358; 362/122

(57) ABSTRACT

A pumpkin carving kit includes at least one pattern formed from a relatively thin, relatively flexible and relatively non-porous material that is substantially impervious to moisture. The pattern includes at least one cutout portion having a plurality of edges. The kit further includes a marking tool for marking an outline of the edges of the cutout portion(s) onto an exterior surface of a pumpkin. The kit further includes at least one cutting tool for carving the outline of the cutout portion(s) onto the exterior surface of the pumpkin. The kit further includes an illumination source for being positioned within the pumpkin to illuminate the cutout portion(s) when the pumpkin is viewed from an external perspective. The cutout portion(s) may define a sexually themed image and the cutting tool may include a handle portion that defines a sexually themed contour.

### FIELD OF THE INVENTION

The present invention relates generally to a pumpkin carving kit, and more particularly, to a pumpkin carving kit for carving a sexually themed image onto a pumpkin including at least one pattern defining the sexually themed image.

### BACKGROUND OF THE INVENTION

Pumpkin carving is a traditional means of celebrating the Halloween season. In the past, organic pumpkins have been carved by cutting away a portion of the shell near the stem or bottom and removing the strings, seeds and pulp from the interior of the pumpkin. An image is then formed on the exterior surface of the pumpkin using some form of cutting tool, such as pumpkin saw, paring knife, pocket knife or scissors blade. The image may first be transferred to the exterior surface of the pumpkin using a pattern having a cutout portion and a marking tool, such as a pen, marker or wax crayon. Once the image is formed, it may be illuminated by a light source positioned within the pumpkin, such as a candle or artificial light.

Some people prefer to carve an organic pumpkin because they enjoy making traditional Halloween treats using the strings, seeds and pulp removed from the interior of the pumpkin. However, most people find removing the strings, seeds and pulp to be time consuming and messy, and end up disposing of the pumpkin interior without utilizing the strings, seeds and pulp. Thus, many people would prefer to carve a pumpkin within a reasonable period of time without having to take additional precautions to protect their clothing and furnishings (e.g. table, desk, countertop, etc.) from the messiness of the contents of the pumpkin interior.

As a result, the use of artificial pumpkins having a hollow interior has increased significantly in recent years as suitable materials have been developed for forming a carvable artificial pumpkin. A further advantage is that a carvable artificial pumpkin is recyclable and may be used from year to year with the same or additional carvings. A carvable artificial pumpkin having a hollow interior and a shell made of a polyurethane foam material is shown and described in U.S. Pat. No. 6,555,188 and related patents issued to Chapman, the disclosures of which are incorporated herein by reference.

When utilized, patterns for transferring an image to a pumpkin have historically been made from thin, flexible paper material that is capable of closely conforming to the irregular contour of the exterior surface of the pumpkin. Pumpkin carving patterns made from paper, however, are frequently weakened and ultimately destroyed by the liquid from the pulp of an organic pumpkin. If used with a carvable artificial pumpkin, oftentimes the delicate paper pattern is damaged by a cutting tool or a marking tool when the cutout portion of the pattern is traced. In other instances, the paper pattern is torn while being removed after being adhered to the exterior surface of the pumpkin.

More durable cutting dies, such as described in U.S. Pat. No. 6,342,175 B1 issued to Brown et al. and U.S. Pat. No. 6,267,036 issued to Lani, as well as transfer patterns, such as described in U.S. Pat. No. 6,093,446 issued to Bardeen and U.S. Pat. No. 6,855,224 issued to Wendler, are available. Cutting dies, however, are cumbersome, typically require a driving tool to impale the cutting die onto the exterior surface of the pumpkin and are inherently limited in complexity. Transfer patterns are similarly cumbersome, require additional expertise to use, and are typically not reusable.

For various reasons, the Halloween holiday has evolved from the traditional children's activity of trick-or-treating wearing costumes having a horror theme into adults wearing fanciful costumes and celebrating with alcoholic beverages and party decorations. Almost all bars, clubs and other drinking establishments feature Halloween events that cater to the heightened expression of sexuality that typically accompanies adults wearing costumes and consuming alcohol. The pumpkin remains the traditional Halloween party decoration. However, existing patterns for transferring an image onto the exterior surface of a pumpkin have not evolved along with the increase in adult-oriented celebrations, and instead, have continued to evoke a horror theme that is more suitable for use with the traditional children's activities associated with Halloween. As a result, it is difficult for a promoter of an adult-oriented Halloween celebration to locate party decorations, and in particular pumpkins, having a suitable theme.

Accordingly, there is a need for a pumpkin carving kit for carving an image onto the exterior surface of a pumpkin that is useable with either an organic pumpkin or a carvable artificial pumpkin. There exists a further need for a pumpkin carving kit including a pattern for transferring an image to a pumpkin that is both durable and reusable, while closely conforming to the exterior surface of the pumpkin. There exists a further, and more particular, need for a pumpkin carving kit including a pattern for transferring an image having a theme suitable for an adult-oriented Halloween celebration onto the exterior surface of a pumpkin.

### BRIEF SUMMARY OF THE INVENTION

The aforementioned disadvantages are overcome by, and the above needs, objectives and advantages, as well as others that will be readily apparent to those skilled in the art, are provided by a pumpkin carving kit according to the present invention. In an exemplary embodiment, the present invention provides a pumpkin carving kit including at least one pattern formed from a relatively thin, relatively flexible and relatively non-porous material that is substantially impervious to moisture. The at least one pattern includes at least one cutout portion comprising a plurality of edges. The kit further includes a marking tool for marking an outline of the edges of the at least one cutout portion of the pattern onto an exterior surface of a pumpkin. The kit further includes at least one cutting tool for carving the outline of the at least one cutout portion onto the pumpkin. The kit further includes an illumination source adapted to be positioned within the pumpkin for illuminating the cutout portion when the pumpkin is viewed from an external perspective.

In one aspect, the pumpkin is a carvable artificial pumpkin defining a generally hollow interior. The carvable artificial pumpkin may be formed from a polyurethane foam material having a nominal density of between about 2.5 and about 3.0 pounds per cubic foot. In addition, the exterior surface of the carvable artificial pumpkin may include a relatively thin coating formed from an acrylic elastomer.

In another aspect, the pumpkin may be an organic pumpkin including a shell having strings, seeds and pulp disposed within the shell and the kit may further include a scoop for removing the strings, seeds, and pulp from within the shell to form a generally hollow interior.

In yet another aspect, the at least one pattern is formed from a relatively thin plastic sheet. The plastic sheet may be selected from the group consisting of polyethylene terephthalate (PET), polyurethane, polypropylene and Mylar®. The at least one cutout of the at least one pattern preferably defines a sexually themed image.

In yet another aspect, the illumination source includes a housing, a light emitting diode (LED), a curved reflector surface and a power source. The power source may be at least one battery. The illumination source may further include at least one anchor for securing the housing to the pumpkin.

In still another aspect, the at least one cutting tool is selected from the group consisting of a piercing tool, a rough-cut tool and a fine-cut tool. The at least one cutting tool preferably includes one or more of a piercing tool, a rough-cut tool and a fine-cut tool. The at least one cutting tool may include a cutting portion and a handle portion that defines a sexually themed contour. The sexually themed contour may depict human anatomy.

In another exemplary embodiment the present invention provides a novelty pumpkin carving kit for carving a sexually themed image onto a pumpkin. The kit includes a carvable artificial pumpkin formed from a polyurethane foam material. The kit further includes at least one pattern formed from a relatively thin, relatively flexible and relatively non-porous material that is substantially impervious to moisture, the at least one pattern including at least one cutout portion comprising a plurality of edges that define the sexually themed image. The kit further includes a marking tool for marking an outline of the edges of the at least one cutout portion of the pattern onto an exterior surface of a generally hollow pumpkin. The kit further includes at least one cutting tool for carving the outline of the at least one cutout portion onto the pumpkin, the at least one cutting tool comprising a cutting portion and a handle portion that defines a sexually themed contour. The kit further includes an illumination source adapted to be positioned within the pumpkin for illuminating the sexually themed image when the pumpkin is viewed from an external perspective. The kit further includes a generally hollow, box-like container for storing the carvable artificial pumpkin, the at least one pattern, the marking tool, the at least one cutting tool and the illumination source. At least one exterior surface of the container includes printed indicia illustrating the sexually themed image.

In yet another exemplary embodiment, the present invention provides a method of carving a sexually themed image onto a pumpkin. The method includes providing a pumpkin having an exterior surface and defining a generally hollow interior, a pattern including at least one cutout portion comprising a plurality of edges that define the sexually themed image, a marking tool for marking an outline of the edges of the at least one cutout portion of the pattern onto the exterior surface of the pumpkin, and a cutting tool for carving the outline of the at least one cutout portion onto the exterior surface of the pumpkin. The method further includes placing the pattern against the exterior surface of the pumpkin and using the marking tool to trace an outline of the plurality of edges of the cutout portion that define the sexually themed image onto the exterior surface of the pumpkin. The method further includes using the cutting tool to carve the outline of the sexually themed image onto the exterior surface of the pumpkin.

### BRIEF DESCRIPTION OF THE DRAWINGS

A pumpkin carving kit according to the present invention is best understood by reference to the following detailed description taken in conjunction with the accompanying drawing figures.

FIG. 1 is a perspective view illustrating a pumpkin having a sexually themed image carved onto the exterior surface of the pumpkin.

FIG. 2 is a schematic view showing the contents of a pumpkin carving kit according to the present invention.

FIG. 3 is a plan view showing a typical pattern of the pumpkin carving kit of FIG. 2 wherein the pattern includes a cutout portion having a plurality of edges defining a sexually themed image.

FIG. 4 is a plan view showing a typical plurality of cutting tools of the pumpkin carving kit of FIG. 2 wherein at least one of the cutting tools includes a cutting portion and a handle portion defining a sexually themed contour.

### DETAILED DESCRIPTION OF THE INVENTION

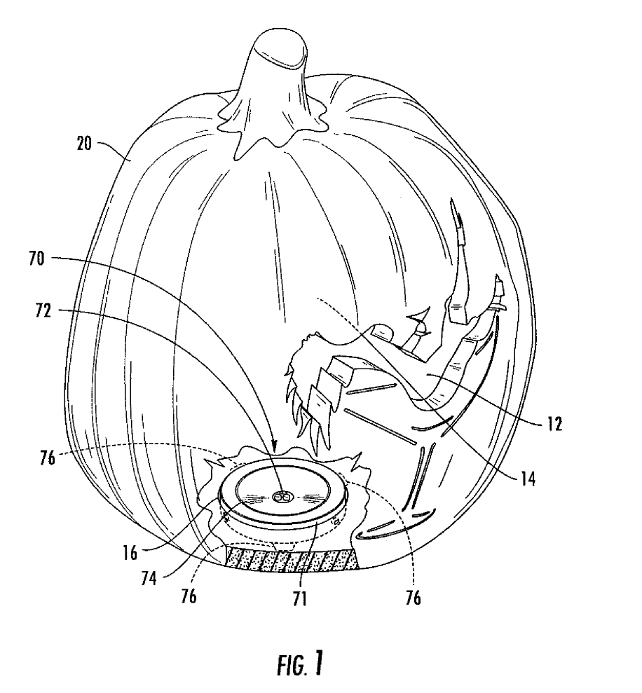

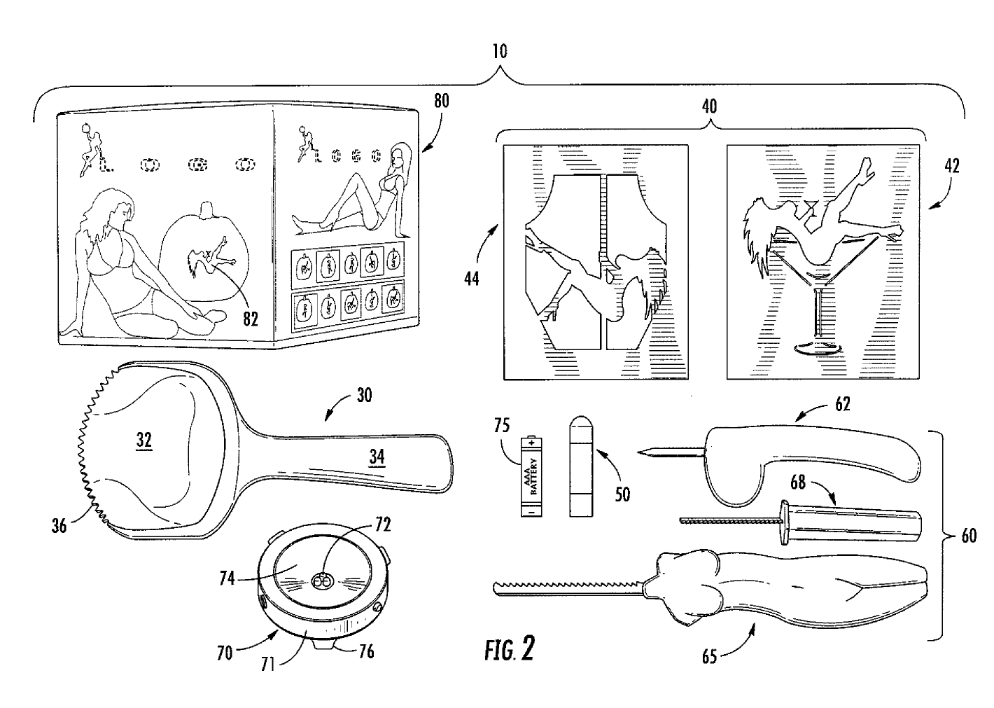

Referring to the drawing figures wherein identical reference numerals denote the same elements throughout the various views, FIG. 1 illustrates a pumpkin, indicated generally at 20, having a sexually themed image 12 carved onto the exterior surface of the pumpkin. The sexually themed image 12 is carved onto the exterior surface of the pumpkin 20 using a pumpkin carving kit, indicated generally at 10 in FIG. 2, according to the present invention, as will be described in greater detail hereinafter. The pumpkin 20 has a generally hollow interior 14 and may have an opening 16 formed through the bottom for accessing the hollow interior. As shown, an illumination source 70 to be described in greater detail hereinafter is positioned within the interior 14 of the pumpkin 20 to illuminate the sexually themed image 12 from an exterior perspective. As a result, the details of the sexually themed image 12 are enhanced relative to the exterior surface of the pumpkin 20. The illumination source may comprise at least one tab, projection or anchor 76, as necessary for affixing the illumination source to the pumpkin 20. Alternatively, the illumination source may be positioned within the interior 14 of the pumpkin 20 with the pumpkin merely placed over the illumination source.

The pumpkin 20 may be a conventional organic pumpkin or may be a carvable artificial pumpkin. In the former instance, the organic pumpkin is carved in a known manner by cutting the opening 16 through the shell on the bottom of the pumpkin 20 and removing the strings, seeds and pulp from the interior 14 using the scoop 30 provided with the pumpkin carving kit 10 depicted in FIG. 2. The scoop 30 may be any instrument or tool suitable for removing the strings, seeds and pulp from the interior 14 of the pumpkin 20. As shown, the scoop 30 is a conventional shovel-like scoop comprising a bowl portion 32 at one end, a handle portion 34 at the opposite end and a cutting portion 36 disposed along the forward edge of the bowl portion, and is used in a well known manner to remove the internal contents of the pumpkin 20. The sexually themed image 12 is then formed on the exterior surface of the pumpkin using the at least one pattern 40, the marking tool 50 and the at least one cutting tool 60 of the kit 10, in the manner to be described hereinafter. Once the image 12 has been formed, the illumination source 70 of the kit 10 is positioned within the interior 14 of the pumpkin 20 to illuminate sexually themed image 12 from an external perspective.

In the latter instance, a carvable artificial pumpkin is included with the kit 10. The pumpkin 20 may be any commercially available artificial pumpkin made of a material that is carvable using the type of cutting blades on the cutting tools 60 that are provided with the kit 10. For example, but without limitation, the pumpkin 20 may be a carvable artificial pumpkin of the type shown and described in U.S. Pat. No. 6,555,188 and related patents issued to Chapman. Accordingly, the pumpkin 20 may be a carvable artificial pumpkin defining a generally hollow interior 14 that is formed from a polyurethane foam material having a nominal density of between about 2.5 and about 3.0 pounds per cubic foot. Furthermore, the carvable artificial pumpkin 20 may comprise a relatively thin coating formed from an acrylic elastomer to form the exterior surface.

FIG. 2 shows the contents of the pumpkin carving kit 10. In an exemplary embodiment, the pumpkin carving kit 10 comprises at least one pattern 40, a marking tool 50, at least one cutting tool 60 and an illumination source 70. The at least one pattern 40 is formed from a relatively thin, relatively flexible and relatively non-porous material that is substantially impervious to moisture. As shown, the at least one pattern 40 comprises two patterns 42, 44 each configured for forming a different sexually themed image 12 onto the exterior surface of the pumpkin 20. However, the pumpkin carving kit 10 may include any number of patterns and the patterns may or may not form a sexually themed image 12. For example, the pumpkin carving kit 10 may comprise patterns 40 consisting of a variety of different patterns having a sexual theme, other theme (e.g., horror theme; traditional Halloween costume theme; etc) or a combination of sexual theme and other theme patterns.

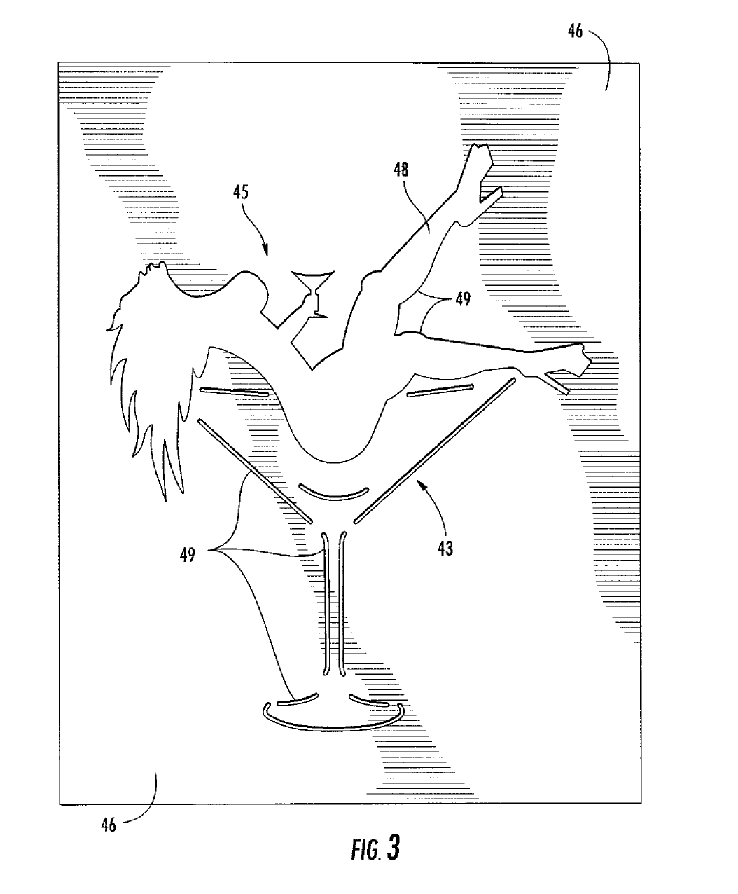

FIG. 3 shows a typical pattern 42 that may be included in the pumpkin carving kit 10 in greater detail. The pattern 42 comprises a thin plastic film or plastic sheet 46 that is relatively thin, relatively flexible and relatively non-porous so as to be substantially impervious to moisture. The sheet 46 is preferably made of a plastic material so as to be durable and reusable. The sheet 46 is preferably thin and flexible so as to conform to the exterior surface of the pumpkin 20, whether the pumpkin is organic, and thus relatively irregular in contour, or artificial, and thus relatively regular in contour. The sheet 46 is preferably non-porous and impervious to moisture to prevent the pulp of an organic pumpkin 20 from damaging or destroying the pattern 42. By way of example and not limitation, the material of the plastic sheet 46 is selected from the group consisting of polyester, polyethylene terephthalate (PET), polyurethane, polypropylene and Mylar®. In a particularly advantageous embodiment, the plastic sheet 46 is formed of a substantially translucent Mylar® material having a thickness of between about 0.10 inches (0.0025 mm) and about 0.25 inches (0.0635 mm). Mylar® is a registered trademark owned by Dupont Tejjin Films for a specific family of plastic products made from the resin polyethylene terephthalate (PET).

Regardless, the pattern 42 further comprises at least one cutout portion 48 having a plurality of edges 49 that define the sexually themed image 12. The edges 49 of the cutout portion 48 of the pattern 42 shown in FIG. 3 define a giant-sized martini glass, indicated generally at 43, and a woman reclining in the giant-sized martini glass while holding a conventional-sized martini glass, indicated generally at 45. However, as previously mentioned, the pattern 42 is but one example of any number of possible sexually themed images 12 that may be included with the pumpkin carving kit 10.

The marking tool 50 may comprise any conventional instrument or tool for marking an outline of the edges 49 of the at least one cutout portion 48 of the at least one pattern 40 on the exterior surface of the pumpkin 20. By way of example and without limitation, the marking tool 50 may be a pen, marker or any other device suitable for visually indicating the edges 49 (i.e. the contour of the cutout portion 48) on the exterior surface of the pumpkin 20. In a particularly advantageous embodiment, the marking tool 50 is a wax crayon so that the residual visual indications of the contour of the cutout portion 48 can be removed from the exterior surface of the pumpkin 20 once the image 12 has been carved.

The at least one cutting tool 60 may comprise any conventional instrument or tool suitable for carving the outline of the at least one cutout portion 48 of the at least one pattern 40 onto the exterior surface of the pumpkin 20. By way of example and without limitation, the at least one cutting tool 60 may comprise a plurality of cutting tools selected from the group consisting of a piercing tool, a rough-cut tool and a fine-cut tool. In a particularly advantageous embodiment, the at least one cutting tool 60 of the pumpkin carving kit 10 comprises one or more of a piercing tool 62, a rough-cut tool 65 and a fine-cut tool 68.

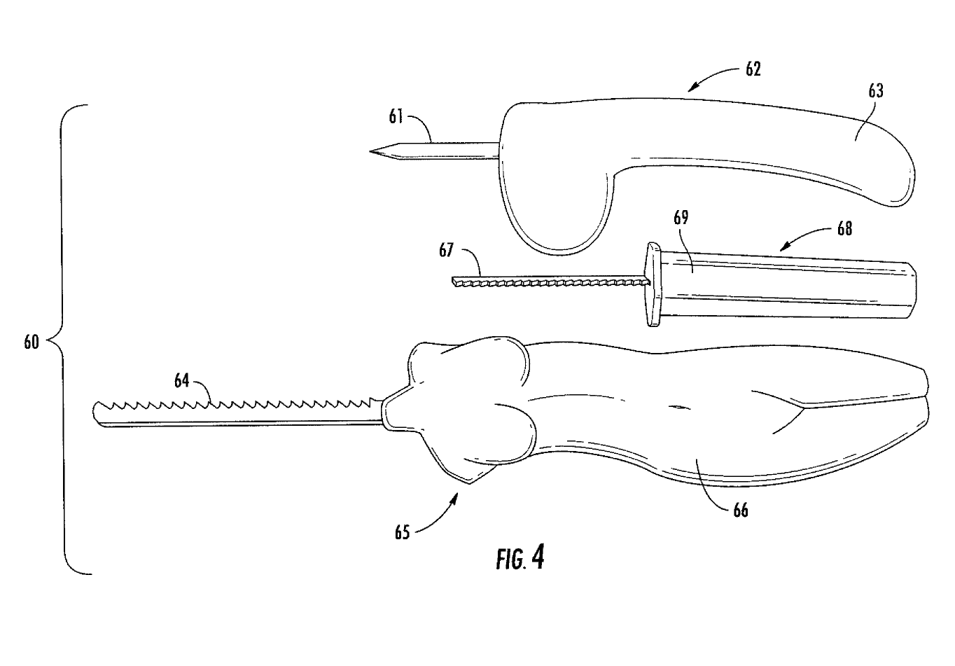

FIG. 4 shows a typical plurality of cutting tools 60 that may be included with the pumpkin carving kit 10. In an exemplary embodiment, at least one of the plurality of cutting tools 60 comprises a cutting portion and a handle portion defining a sexually themed contour. As shown, the piercing tool 62 comprises a cutting portion 61 for piercing a hole through the exterior surface of the pumpkin 20 to the hollow interior 14 and a handle portion 63 defining a contour having a sexual theme. Likewise, the rough-cut tool 65 comprises a cutting portion 64 for making rough cuts through the exterior surface of the pumpkin 20 to the hollow interior 14 and a handle portion 66 defining a contour having a sexual theme. The fine-cut tool 68 comprises a cutting portion 67 for making fine cuts through the exterior surface of the pumpkin 20 to the hollow interior 14 and a handle portion 69 defining a contour. The contour of the handle portion 69 does not have a sexual theme, but may have a sexual theme if desired. As shown herein, the sexually themed contours defined by the handle portions 63, 66 depict human anatomy. However, the contour(s) of the handle portion(s) may or may not have a sexual theme. For example, the pumpkin carving kit 10 may comprise handle portions 63, 66 defining a variety of different contours that have a sexual theme, other theme (e.g., horror theme; traditional Halloween costume theme; etc) or a combination of sexual theme and other theme handle portions.

The illumination source 70 may comprise any conventional instrument or device for producing visual light and projecting the light outwardly from the illumination source. By way of example and without limitation, the illumination source may comprise a housing 71, at least one light emitting diode (LED) 72, a curved reflector surface 74, and a power source 75. In a particularly advantageous embodiment, the reflector surface 74 has a concave curvature and the at least one LED 72 is located at the lowest point of the reflector surface. Furthermore, the housing is sized to receive the power source 75 consisting of at least one conventional battery and a pair of lead wires forming an electrical circuit with the at least one LED. As previously mentioned, the illumination source 70 may further comprise one or more tabs, projections or anchors 76 for affixing the illumination source to the pumpkin 20. In this manner, the illumination source 70 may be affixed to any portion of the pumpkin 20 as desired, including the side, top or bottom of the pumpkin.

In another embodiment, a pumpkin carving kit 10 kit according to the present invention comprises a carvable artificial pumpkin 20, at least one pattern 40, a marking tool 50, at least one cutting tool 60 and an illumination source 70 essentially as previously described in all relevant respects. In addition, the pumpkin carving kit 10 comprises a generally hollow, box-like container 80 for storing the carvable artificial pumpkin 20, the at least one pattern 40, the marking tool 50, the at least one cutting tool 60 and the illumination source 70. Furthermore, at least one exterior surface of the container 80 includes printed indicia thereon comprising a sexually themed image 82.

In yet another embodiment, a method of carving a sexually themed image 12 onto a pumpkin 20 according to the present invention includes providing a pumpkin having an exterior surface and defining a generally hollow interior 14, a pattern 40 including at least one cutout portion 48 comprising a plurality of edges 49 that define the sexually themed image, a marking tool 50 for marking an outline of the edges of the at least one cutout portion of the pattern onto the exterior surface of the pumpkin, and a cutting tool 60 for carving the outline of the at least one cutout portion onto the exterior surface of the pumpkin. The method further includes placing the pattern 40 against the exterior surface of the pumpkin 20 and using the marking tool 50 to trace an outline of the plurality of edges 49 of the cutout portion 48 that define the sexually themed image 12 onto the exterior surface of the pumpkin 20. The method further includes using the cutting tool 60 to carve the outline of the sexually themed image 12 onto the exterior surface of the pumpkin 20. In a particularly advantageous embodiment, the method further includes providing an illumination source 70 and positioning the illumination source within the generally hollow interior 14 of the pumpkin 20 such that the sexually themed image 12 is more clearly viewable from an external perspective.

The foregoing has described exemplary embodiments of a pumpkin carving kit for carving a sexually themed image onto the exterior surface of a pumpkin. The pumpkin may be an organic pumpkin or an a carvable artificial pumpkin formed from a polyurethane foam material having a nominal density of between about 2.5 and about 3.0 pounds per cubic foot. Furthermore, the pumpkin carving kit comprises at least one durable, yet flexible pattern including at least one cutout portion having a plurality of edges that define a sexually themed image.

While particular embodiments of the present invention have been described, it will be apparent to those skilled in the art that various modifications thereto can be made without departing from the spirit and scope of the invention. Accordingly, the foregoing description of the preferred embodiments of the invention and the best mode for practicing the invention are provided for the purpose of illustration only and not for the purpose of limitation.

1. A pumpkin carving kit comprising:
at least one pattern formed from a relatively thin, relatively flexible and relatively non-porous material that is substantially impervious to moisture, the at least one pattern including at least one cutout portion comprising a plurality of edges;
a marking tool for marking an outline of the edges of the at least one cutout portion of the pattern onto an exterior surface of a pumpkin;
at least one cutting tool for carving the outline of the at least one cutout portion onto the pumpkin; and
an illumination source adapted to be positioned within the pumpkin for illuminating the cutout portion when the pumpkin is viewed from an external perspective;
wherein the edges of the at least one cutout portion of the pattern define a sexually themed image that depicts a human body.

2. A pumpkin carving kit according to claim 1, further comprising a carvable artificial pumpkin defining a generally hollow interior.

3. A pumpkin carving kit according to claim 2, wherein the carvable artificial pumpkin is formed from a polyurethane foam material having a nominal density of between about 2.5 and about 3.0 pounds per cubic foot.

4. A pumpkin carving kit according to claim 3, wherein the exterior surface of the carvable artificial pumpkin comprises a relatively thin coating formed from an acrylic elastomer.

5. A pumpkin carving kit according to claim 1, further comprising an organic pumpkin having an outer shell and strings, seeds and pulp disposed within the shell, and a scoop for removing the strings, seeds and pulp from within the shell to form a generally hollow interior.

6. A pumpkin carving kit according to claim 1, further comprising a generally hollow, box-like container for storing the contents of the kit.

7. A pumpkin carving kit according to claim 6, wherein at least one exterior surface of the container includes printed indicia comprising a sexually themed image that depicts a human body.

8. A pumpkin carving kit according to claim 1, wherein the at least one pattern is formed from a relatively thin plastic sheet.

9. A pumpkin carving kit according to claim 8, wherein the plastic sheet is selected from the group consisting of polyester, polyethylene terephethalate (PET), polyurethane and polypropylene.

10. A pumpkin carving kit according to claim 8, wherein the sexually themed image comprises at least one anatomical feature of the human body.

11. A pumpkin carving kit according to claim 1, wherein the marking tool comprises a wax crayon.

12. A pumpkin carving kit according to claim 1, wherein the illumination source comprises a housing, a light emitting diode (LED), a curved reflector surface and a power source.

13. A pumpkin carving kit according to claim 12, wherein the power source comprises at least one battery.

14. A pumpkin carving kit according to claim 12, wherein the illumination source further comprises at least one anchor for securing the housing to the pumpkin.

15. A pumpkin carving kit according to claim 1, wherein the at least one cutting tool comprises one or more of a piercing tool, a rough-cut tool and a fine cut tool.

16. A pumpkin carving kit according to claim 1, wherein the at least one cutting tool comprises a cutting portion and a handle portion defining a sexually themed contour that depicts human anatomy.

17. A pumpkin carving kit according to claim 16, wherein the sexually themed contour comprises at least one anatomical feature of a human body.

18. A novelty pumpkin carving kit for carving a sexually themed image that depicts a human body and comprises at least one anatomical feature of the human body onto a pumpkin, the kit comprising:
a carvable artificial pumpkin formed from a polyurethane foam material;
at least one pattern formed from a relatively thin, relatively flexible and relatively non-porous material that is substantially impervious to moisture, the at least one pattern including at least one cutout portion comprising a plurality of edges that define the sexually themed image;
a marking tool for marking an outline of the edges of the at least one cutout portion of the pattern onto an exterior surface of the carvable artificial pumpkin;
at least one cutting tool for carving the outline of the at least one cutout portion onto the carvable artificial pumpkin, the at least one cutting tool comprising a cutting portion and a handle portion defining a sexually themed contour that depicts human anatomy;
an illumination source adapted to be positioned within the pumpkin for illuminating the sexually themed image when the carvable artificial pumpkin is viewed from an external perspective; and
a generally hollow, box-like container for storing the carvable artificial pumpkin, the at least one pattern, the marking tool, the at least one cutting tool and the illumination source, at least one exterior surface of the container including printed indicia comprising the sexually themed image.

19. A method of carving a sexually themed image that depicts a human body comprising an anatomical feature onto a pumpkin, the method comprising:
providing a pumpkin having an exterior surface and defining a generally hollow interior, a pattern including at least one cutout portion comprising a plurality of edges that define the sexually themed image, a marking tool for marking an outline of the edges of the at least one cutout portion of the pattern onto the exterior surface of the pumpkin, and a cutting tool for carving the outline of the at least one cutout portion onto the exterior surface of the pumpkin;
placing the pattern against the exterior surface of the pumpkin;
using the marking tool to trace an outline of the plurality of edges of the cutout portion that define the sexually themed image onto the exterior surface of the pumpkin; and
using the cutting tool to carve the outline of the sexually themed image onto the exterior surface of the pumpkin.

20. The method according to claim 19, further comprising:
providing an illumination source; and
positioning the illumination source within the generally hollow interior of the pumpkin such that the sexually themed image is viewable from an external perspective.
